(19) United States
(12) Patent Application Publication
(10) Pub. No.: US 2009/0066373 A1
(43) Pub. Date: Mar. 12, 2009

(54) DEVICE FOR ADJUSTING CHIP OUTPUT CURRENT AND METHOD FOR THE SAME

(75) Inventor: Yi-Lin Chen, HsinChu (TW)

Correspondence Address: APEX JURIS, PLLC, 12733 LAKE CITY WAY NORTHEAST, SEATTLE, WA, 98125, US

(73) Assignee: REALTEK SEMICONDUCTOR CORP., HsinChu (TW)

(21) Appl. No.: 12/204,067

(22) Filed: Sep. 4, 2008

(30) Foreign Application Priority Data
Sep. 7, 2007 (TW) 096133392

(51) Int. Cl. G05F 1/10

(52) U.S. Cl. 327/109

(57) ABSTRACT

A device for adjusting chip output current and a method for the same are provided. The device includes: a driving circuit for outputting a driving current according to a control signal, wherein the driving current flows to a reference resistor in another chip so as to generate an output voltage; and a detecting circuit coupled to the driving circuit and adapted for detecting the output voltage and a reference voltage, so as to generate the control signal; wherein the control signal controls the number of parallel connections of NMOS transistors or PMOS transistors in the driving circuit, so as to adjust the magnitude of the driving current.

### CROSS-REFERENCES TO RELATED APPLICATIONS

This non-provisional application claims priority under 35 U.S.C. § 119(a) on Patent Application No(s) 096133392 filed in Taiwan, R.O.C. on 2007, Sep. 7, the entire contents of which are hereby incorporated by reference.

### FIELD OF THE INVENTION

The present invention is related to a device for adjusting current and a method for the same, and more particularly, to a device for adjusting chip output current and a method for the same.

### DESCRIPTION OF PRIOR ART

In general, dynamic random access memory (DRAM) is divided into several categories, namely SDR DRAM, DDR DRAM, etc. Among others, SDR DRAM enables its data to be accessed once per timing cycle. For instance, a stream of data is transmitted once at every positive clock edge. Hence, SDR DRAM is known as single data rate (SDR) memory module. DDR DRAM is similar to SDR DRAM in that both are dynamic random access memory (DRAM), but DDR DRAM provides data access by double data rate (DDR) technology. Double data rate (DDR) technology enables DDR DRAM to transmit two streams of data per timing cycle, i.e. transmitting data once at positive clock edge and negative clock edge respectively. The positive edge of a timing cycle is referred to as the rising time. The negative edge of a timing cycle is referred to as the falling time. To enable DDR DRAM to function well, it is of vital importance that the rising time and the falling time be of equal duration, otherwise a loss of duty-cycle fidelity will occur (i.e. short of a 50% duty cycle), which in turn affects the timing margin of the rising time and the falling time. To keep the rising time and the falling time almost the same, charging current and discharging current should be adjusted. That is, to adjust charging current and discharging current, output current of a driving circuit in a chip should be calibrated appropriately.

Conventional methods for calibrating output current usually involve connecting a resistor to a printed circuit board (PCB) externally so as to enable the chip to undergo current calibration. However, the drawbacks of the prior art are that in addition to an external resistor the conventional methods of output current calibration require an extra pin, thereby increasing the costs of fabrication. Considering the trend toward miniaturization of semiconductor chips, every pin in a chip is precious. Hence, the drawbacks of the prior art call for an immediate solution, and a new method of calibration that overcomes the drawbacks of the prior art is in urgent demand.

### SUMMARY OF THE INVENTION

In view of this, both a device for adjusting chip output current and a method for the same are proposed by the invention. The device and the method of the present invention spare an external resistor and accomplish control of driving current outputted by the chip.

A device for adjusting chip output current is proposed by the invention. The device for adjusting chip output current comprises: a driving circuit for outputting a driving current according to a control signal wherein the driving current flows to a reference resistor in another chip so as to generate an output voltage; a detecting circuit coupled to the driving circuit and adapted for detecting the output voltage and a reference voltage, so as to generate the control signal; wherein the control signal controls a number of parallel connections of NMOS transistors or PMOS transistors in the driving circuit, so as to adjust the magnitude of the driving current.

A method for adjusting chip output current is also proposed by the invention. The method for adjusting chip output current comprises the steps of: outputting a driving current according to a control signal, wherein the driving current flows to a reference resistor in another chip so as to generate an output voltage; and detecting the output voltage and a reference voltage, so as to generate the control signal; wherein the control signal controls a number of parallel connections of NMOS transistors or PMOS transistors, so as to adjust magnitude of the driving current.

The preferred embodiments, functions, and benefits of the present invention are described hereunder in conjunction with the drawings.

### BRIEF DESCRIPTION OF THE DRAWINGS

FIG. 1 is a schematic view of a first preferred embodiment of the present invention;

FIG. 2 is a schematic view of a second preferred embodiment of the present invention;

FIG. 3 is a schematic view of a third preferred embodiment of the present invention; and

FIG. 4 is a flow chart of a method for adjusting current according to the present invention.

### DETAILED DESCRIPTION OF PREFERRED EMBODIMENTS

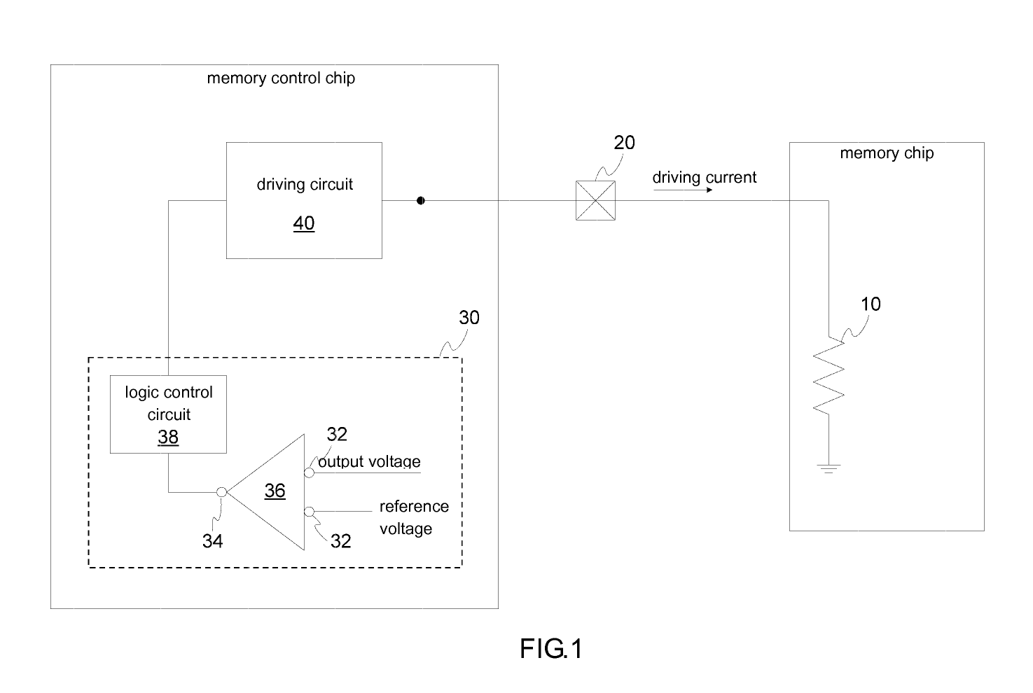

Refer to FIG. 1, which is a schematic view of a first preferred embodiment of the present invention. In this embodiment, a device for adjusting memory output current comprises: an on-die termination (ODT) resistor 10, a data pin (DQ) 20, a detecting circuit 30, and a driving circuit 40. The detecting circuit 30 further comprises a comparator 36 and a logic control circuit 38. The detecting circuit 30 and the driving circuit 40 are placed in a memory control chip. The on-die termination resistor 10 is placed in a memory chip.

Joint Electron Device Engineering Council (JEDEC) have issued many electronic engineering standards. Among other memory standards, such as DDR2, an on-die termination (ODT) resistor is one of the components indispensable to a standard memory specified by JEDEC. An on-die termination resistor is essentially a terminal for DDR signals, and is configured to maintain signal integrity and enhance system stability. Owing to the increasingly high speed of memory, on-die termination resistors are incorporated into memory outright to shorten routes and render memory time-efficient. Another advantage of on-die termination resistor technology is that on-die termination resistors reduce feedback to memory operating at high speed, enhance memory performance, and increase clock limit.

Hence, according to an embodiment of the present invention, a built-in resistor in a memory chip in the form of an on-die termination (ODT) resistor provides the resistance required for current calibration. With a built-in on-die termination resistor, current output from a memory control end can be calibrated without providing an additional resistor to a memory module externally, thus sparing the cost of a printed circuit board (the prior art presents soldering an external resistor to a printed circuit board to facilitate calibration) and the cost of the external resistor.

In the first preferred embodiment, a memory chip has a built-in on-die termination resistor placed therein to provide reference resistance. In this regard, the reference resistance is, but not limited to, 50 ohms. Also, the second chip is a dynamic random access memory (DRAM) chip.

In an embodiment of the present invention, existing data pins or clock pins of a memory chip are proposed to replace additional pins (hereinafter exemplified by data pins) used by the prior art. For instance, 8-bit memory has data pins denoted by DQ₀˜DQ₇, and 16-bit memory has data pins denoted by DQ₀˜DQ₁₅. Calibration of output current can be performed with only a single data pin. The present invention overcomes drawbacks of the prior art, namely problems resulting from the lack of a redundant pin at the memory control end, and the costs incurred in adding an extra pin.

In the first preferred embodiment, a data (DQ) pin 20 has one end coupled to an on-die termination resistor 10 and the other end coupled to the driving circuit 40. The data pin 20 outputs driving current for driving the memory to access data. Once the driving current flows through the on-die termination resistor 10, the on-die termination resistor 10 generates output voltage.

The detecting circuit 30 comprises the comparator 36 and the logic control circuit 38. The comparator 36 has an input end 32 and an output end 34. The input end 32 receives the output voltage and reference voltage at the on-die termination resistor 10 and compares the output voltage with the reference voltage so as to output a logic value. The output end 34 is connected to the logic control circuit 38. The logic control circuit 38 is coupled to the comparator 36 to generate a control signal according to the logic value, and send the control signal to the driving circuit 40. The logic control circuit 38 is a finite state machine.

Thus, the reference voltage is a programmable reference voltage. The reference voltage is equal to a half (½), three quarters (¾), a quarter (¼) of operating voltage (Vdd), which is described in detail below. The reference voltage is not limited to the above-mentioned.

The driving circuit 40 manifests resistance inherently. The on-die termination resistor 10 provides reference resistance. Output voltage received by the input end 32 of the detecting circuit 30 is the divided voltage of the on-die termination resistor 10 in a circuit formed by the driving circuit 40 and the on-die termination resistor 10 together. Hence, the reference voltage is set to the resultant voltage, after taking average of and dividing between the respective voltages of the driving circuit 40 and the on-die termination resistor 10 in the circuit formed therewith. Hence, the detecting circuit 30 is capable of comparing the output voltage with the reference voltage and thereby adjusting the driving current outputted by the data pin 20. In other words, the detecting circuit 30 compares the output voltage with the reference voltage and generates, upon discovery of a difference between the two voltages, a logic value from the output end 34. Subsequently, the logic control circuit 38 generates the control signal according to the logic value, and sends the control signal to the driving circuit 40, allowing the data pin 20 to output the driving current of different magnitude. Once the driving current of different magnitude flows through the on-die termination resistor 10 again, output voltage of different magnitude will be generated. Then, the detecting circuit 30 compares the newly generated output voltage and reference voltage, repeating the aforesaid steps and adjusting the driving current outputted by the data pin 20. When detected, an insignificant difference between the output voltage and the reference voltage indicates that resistance of the driving circuit 40 approximates to reference resistance of the on-die termination resistor 10. It is thus confirmed that the driving current outputted by the data pin 20 is the required memory driving current.

In addition, as shown in FIG. 1, the device for adjusting current is placed in a memory control chip, and the memory control chip has a calibration mode and an operation mode. The memory control chip operates at the calibration mode to enable the device for adjusting current and at the operation mode to disable the device for adjusting current. Hence at the initial stage the memory control chip operates at the calibration mode first, the device for adjusting current calibrates output current of the memory control chip. Once a predetermined period of time passes, the memory control chip enters the operation mode at which the memory control chip will access data from the memory chip. In so doing, the memory control chip switches between different modes so as to start the operation of the device for adjusting current.

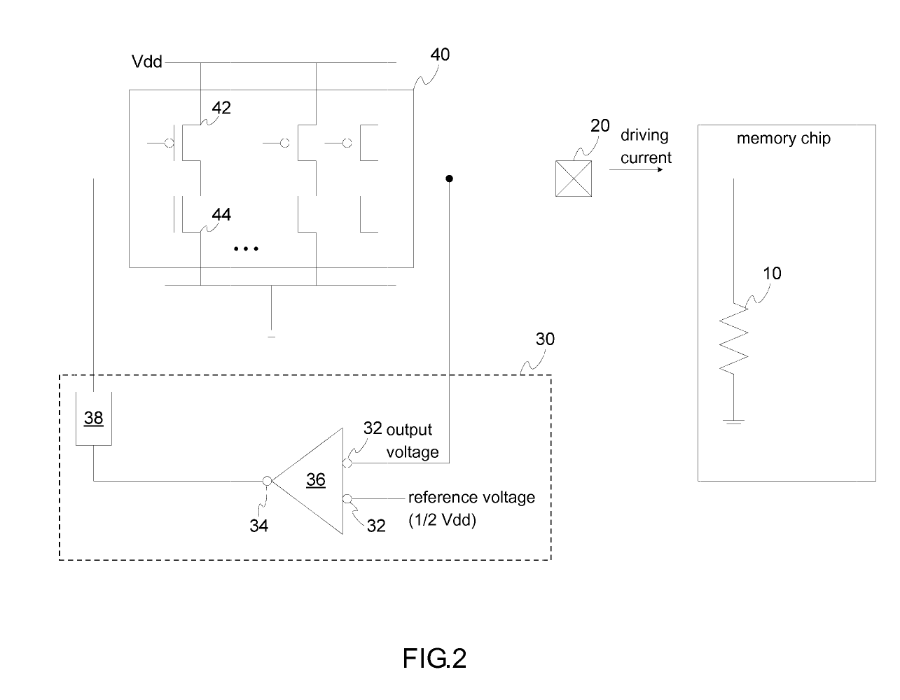

Refer to FIG. 2, which is a schematic view of a second preferred embodiment of the present invention. In this embodiment the driving circuit 40 comprises at least one PMOS transistors 42 and at least one NMOS transistor 44. In the second preferred embodiment, a plurality of PMOS transistors 42 are connected in parallel, and a plurality of NMOS transistors 44 are also connected in parallel. Each of the PMOS transistors 42 is connected to a corresponding one of the NMOS transistors 44 in series.

Positive clock edge takes place, i.e. during the rising time, when the PMOS transistors 42 are on and being charged and the NMOS transistors 44 are off. Conversely, negative clock edge takes place, i.e. during the falling time, when the NMOS transistors 44 are on and being discharged and the PMOS transistors 42 are off. Related description is given hereunder in terms of a charging state and a discharging state.

In the charging state, the PMOS transistors 42 are on, and the NMOS transistors 44 are off; meanwhile, parallel resistance of the PMOS transistors 42 are to be adjusted. Assuming that the on-die termination resistor 10 provides a reference resistance of 50 ohms in the presence of an operating voltage (Vdd) of 1.8 V, the reference voltage is set to a half (½) of the operating voltage, i.e. 0.9 V, as one end of the on-die termination resistor 10 is grounded. In the optimal condition, where the parallel resistance of the PMOS transistors 42 approximates to 50 ohms and the driving current outputted by the data pin 20 flows through the on-die termination resistor 10, parallel resistance of the PMOS transistors 42 almost equals the reference resistance of the on-die termination resistor 10, and thus the output voltage at the on-die termination resistor 10 is nearly half (½) of the operating voltage, i.e. it almost equals the reference voltage, as a result of voltage division.

In practice, owing to a variety of factors in mass production of a semiconductor process, prediction of parallel resistance of the PMOS transistors 42 is seldom accurate. This is the reason why the memory control end must be calibrated before use. Referring to FIG. 2, suppose an output voltage of 1.0 V is generated by the on-die termination resistor 10 when the driving current outputted by the data pin 20 flows through the on-die termination resistor 10. The input end 32 of the detecting circuit 30 receives an input voltage (1.0 V), and thus a comparison between the input voltage (1.0 V) and the reference voltage (0.9 V) is made, which reveals that the input voltage is greater than the reference voltage In other words, the reference resistance of the on-die termination resistor 10 is greater than the parallel resistance of the PMOS transistors 42; meanwhile, the output end 34 of the detecting circuit 30 generates a logic value, and the logic control circuit 38 generates a control signal according to the logic value and sends the control signal to the driving circuit 40. As far as the present example is concerned, given the relatively low parallel resistance of the PMOS transistors 42, a portion of the PMOS transistors 42 are switched off so as to enhance the total parallel resistance of the PMOS transistors 42; meanwhile, owing to the change in the parallel resistance of the PMOS transistors 42, the driving current outputted by the data pin 20 varies accordingly. The adjusted driving current flows through the on-die termination resistor 10 again, and the output voltage varies accordingly. By the detecting circuit 30 comparing the adjusted output voltage with the reference voltage, the parallel resistance of the PMOS transistors 42 is further adjusted. The above steps are repeated until the parallel resistance of the PMOS transistors 42 approximates the reference resistance. At this point, calibration of the driving current in the driving circuit 40 at a charging stage is finalized.

On the other hand, at the discharging stage the NMOS transistors 44 are on and the PMOS transistors 42 are off. Adjustment is performed in the same way as at the charging stage, except that at the discharging stage the parallel resistance of the NMOS transistors 44 is adjusted so as to calibrate the driving current in the driving circuit 40 at the discharging stage.

As revealed by the above description, the detecting circuit 30 adjusts the number of parallel connections of the PMOS transistors 42 and the NMOS transistors 44 and thereby adjusts the parallel resistance of the PMOS transistors 42 and the NMOS transistors 44, so as to adjust the driving current outputted by the data pin 20.

Furthermore, the reference voltage can be a programmable reference voltage such that in case of an ungrounded end of the on-die termination resistor 10 or process drift the user may change the reference voltage, so as to finalize the calibration of output current.

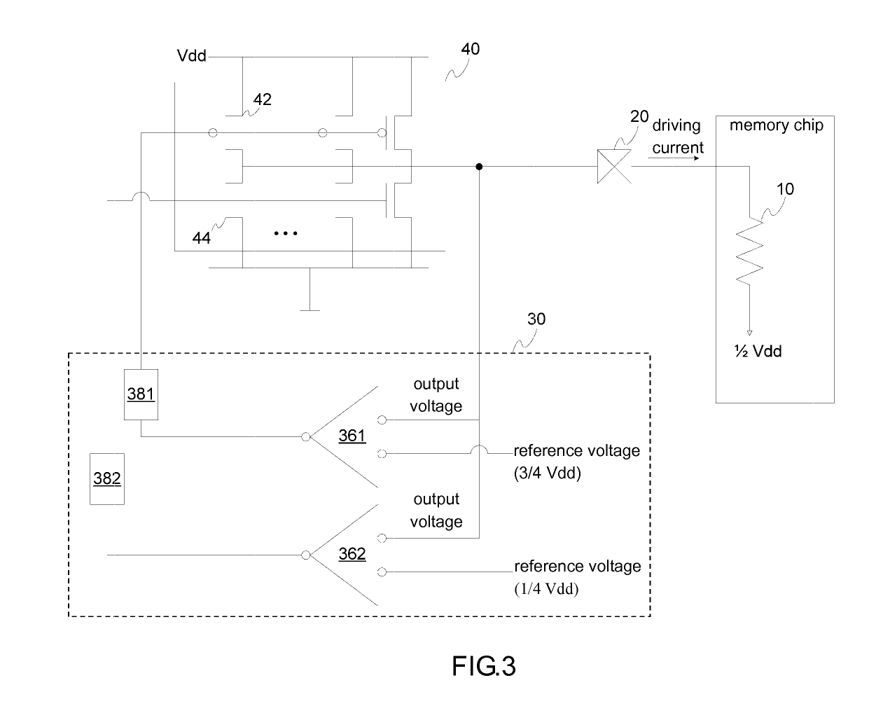

Refer to FIG. 3, which is a schematic view of a third preferred embodiment of the present invention. Differences between the third preferred embodiment and the second preferred embodiment are described below. In the second preferred embodiment, one end of the on-die termination resistor 10 is grounded, and thus the reference voltage is set to a half (½) of the operating voltage. In practice, the on-die termination resistor 10 has one end connected to a half (½) of the operating voltage, and this is the reason why the third preferred embodiment presents the on-die termination resistor 10 with one end connected to a half (½) of the operating voltage. In the third preferred embodiment, along the circuit whereby the PMOS transistors 42 are connected to the on-die termination resistor 10, the PMOS transistors 42 are connected to Vdd, and the on-die termination resistor 10 is connected to ½Vdd, and thus the reference voltage is set to ¾Vdd

$$( \frac{1 + 1 / 2}{2} Vdd ) .$$

By contrast, along the circuit whereby the NMOS transistors 44 are connected to the on-die termination resistor 10, the NMOS transistors 42 are grounded and the on-die termination resistor 10 is connected to ½Vdd, thus the reference voltage is set to ¼Vdd.

Refer to FIG. 3. The third preferred embodiment presents two comparators, namely a PMOS transistor-oriented comparator 361 and a NMOS transistor-oriented comparator 362. The third preferred embodiment also presents two logic control circuits, namely a PMOS transistor-oriented logic control circuit 381 and a NMOS transistor-oriented logic control circuit 382. The reference voltage received by the PMOS transistor-oriented comparator 361 is equal to three quarters (¾) of the operating voltage. The PMOS transistor-oriented logic control circuit 381 adjusts the parallel resistance of the PMOS transistors 42, and further adjusts the driving current at the charging stage. The reference voltage received by the NMOS transistor-oriented comparator 362 is equal to a quarter (¼) of the operating voltage. The NMOS transistor-oriented logic control circuit 382 adjusts the parallel resistance of the NMOS transistors 44, and further adjusts the driving current at the discharging stage.

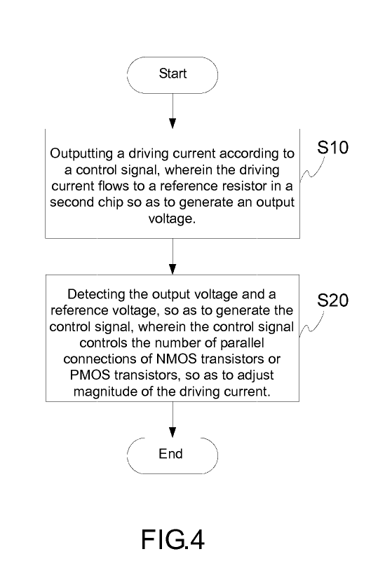

Refer to FIG. 4, which is an embodiment of a flow chart of a method for adjusting current according to the present invention, in which the method for adjusting current according to the present invention is applied to a first chip and comprises the following steps.

Step S10: outputting a driving current according to a control signal, wherein the driving current flows to a reference resistor in a second chip so as to generate an output voltage. In this regard, the first chip is a control chip, and the second chip is a memory chip or a dynamic random access memory (DRAM) chip.

The reference resistor is an on-die termination resistor (as disclosed in an embodiment of the present invention), and is placed in a memory chip; hence, no additional external resistor is required. The driving current flows through a data pin or a clock pin of the memory chip.

Step S20: detecting the output voltage and a reference voltage, so as to generate the control signal, wherein the control signal controls the number of parallel connections of NMOS transistors or PMOS transistors, so as to adjust the magnitude of the driving current. The reference voltage is a programmable reference voltage. Alternatively, the first chip operates at an operating voltage, and the reference voltage is substantively equal to a half of the operating voltage.

The step S20 further comprises the steps of: comparing the output voltage with the reference voltage so as to output a logic value; and generating the control signal according to the logic value.

The aforesaid embodiments merely serve as the preferred embodiments of the present invention. The aforesaid embodiments should not be construed as to limit the scope of the present invention in any way. It will be apparent to those skilled in the relevant fields that all equivalent modifications or changes made to the present invention, without departing from the spirit and the technical concepts disclosed by the present invention, should fall within the scope of the appended claims. Therefore, the protection of the invention should be defined by the appended claims.

What is claimed is:

1. A device for adjusting current, being placed in a first chip, comprising:
a driving circuit, for outputting a driving current according to a control signal, wherein the driving current flows to a reference resistor positioned in a second chip so as to generate an output voltage; and
a detecting circuit, coupled to the driving circuit, for detecting the output voltage and a reference voltage to generate the control signal;
wherein the control signal controls a number of parallel connections of one of NMOS transistors and PMOS transistors in the driving circuit to adjust magnitude of the driving current.

2. The device for adjusting current as claimed in claim 1, wherein the detecting circuit comprising:
a comparator, for comparing the output voltage with the reference voltage to output a logic value; and
a logic control circuit, coupled to the comparator, for generating the control signal according to the logic value.

3. The device for adjusting current as claimed in claim 2, wherein the logic control circuit is a finite state machine.

4. The device for adjusting current as claimed in claim 1, wherein the first chip has a calibration mode and an operation mode, the first chip operating at the calibration mode to enable the device and at the operation mode to disable the device.

5. The device for adjusting current as claimed in claim 1, wherein the reference voltage is a programmable reference voltage.

6. The device for adjusting current as claimed in claim 1, wherein the first chip is a control chip, and the second chip is a memory chip.

7. The device for adjusting current as claimed in claim 6, wherein the driving current flows through one of a data pin and a clock pin of the memory chip.

8. The device for adjusting current as claimed in claim 1, wherein the reference resistor is an on-die termination (ODT) resistor.

9. The device for adjusting current as claimed in claim 1, wherein the driving circuit operates at an operating voltage, and the reference voltage is substantively equal to a half of the operating voltage.

10. The device for adjusting current as claimed in claim 1, wherein the second chip is a dynamic random access memory (DRAM) chip.

11. A method for adjusting current, being applied to a first chip, comprising the steps of:
outputting a driving current according to a control signal, wherein the driving current flows to a reference resistor positioned in a second chip to generate an output voltage; and
detecting the output voltage and a reference voltage to generate the control signal;
wherein the control signal controls a number of parallel connections of one of NMOS transistors and PMOS transistors to adjust the magnitude of the driving current.

12. The method for adjusting current as claimed in claim 11, wherein the detecting step further comprises:
comparing the output voltage with the reference voltage to output a logic value; and
generating the control signal according to the logic value.

13. The method for adjusting current as claimed in claim 11, wherein the reference voltage is a programmable reference voltage.

14. The method for adjusting current as claimed in claim 11, wherein the first chip is a control chip, and the second chip is a memory chip.

15. The method for adjusting current as claimed in claim 14, wherein the driving current flows through one of a data pin and a clock pin of the memory chip.

16. The method for adjusting current as claimed in claim 11, wherein the reference resistor is an on-die termination (ODT) resistor.

17. The method for adjusting current as claimed in claim 11, wherein the first chip operates at an operating voltage, and the reference voltage is substantively equal to a half of the operating voltage.

18. The method for adjusting current as claimed in claim 11, wherein the second chip is a dynamic random access memory (DRAM) chip.
